(19) United States
(12) Patent Application Publication
(10) Pub. No.: US 2006/0248463 A1
(43) Pub. Date: Nov. 2, 2006

(54) Persistant positioning

(76) Inventors: Damien Forkner, Corvallis, OR (US); Daniel N. Debrito, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/118,945

(22) Filed: Apr. 28, 2005

(51) Int. Cl. G05B 19/18

(52) U.S. Cl. 715/730; 715/517; 700/66; 701/207

(57) ABSTRACT

A persistent position method disclosed. The method includes obtaining position data associated with an object. The position data and the object are sent to a client requesting the object. The position data is usable by the client to position a presentation of the object.

### BACKGROUND

Simple web site navigation is achieved mostly through use of the web browser “Back” button. Most modern web browsers remember the scroll point or position of a particular page, and when the user clicks “Back,” the browser automatically scrolls to the proper position. Complicated internet applications, however, often serve dynamically-generated content. Those internet applications often include complex navigation schemes where every button click has a side-effect. For example, a user might be required to click a “Save” button in order to commit some changes, and the use of the browser's “Back” may cause trouble. Executing the browser's “Back” button sends no information to the server, and only pulls the most recent page from the browser's local cache. Most internet applications, in fact, are troubled by the use of the browser's “Back” button, as its use can cause confusing server states and result in ambiguous results. Some internet applications attempt to disable the browser's “Back” button entirely.

### DRAWINGS

FIG. 1 is a schematic view of a network in which embodiments of the present invention may be implemented.

FIG. 2-5 are block diagrams illustrating logical components operating on a server device and one or more client devices according to various embodiments.

FIGS. 6 and 7 are exemplary flow diagrams illustrating steps taken to implement various embodiments of the present invention.

### DETAILED DESCRIPTION

INTRODUCTION: Navigating a complex web site often involves a user starting at a home page, clicking or drilling “down” to a desired page and then navigating back “up” toward the home page. When returning to a previously viewed page within the web site, a user may benefit from being automatically returned to a particular point within that page. For example, a user may scroll down to a particular point within an initial web page where the user selects a link to a secondary web page. Later, the user may select a link in the secondary web page or yet another web page that directs the user back to the initial page. Upon return, the user may prefer to be automatically returned to the particular position within the initial web page-that is-to the position where the user selected the link to access the secondary web page.

Various embodiments described below operate to enable a web server to “remember” a user's last known position within a web page or other object. Upon return to a previously viewed page or object, the web server can instruct or otherwise provide data enabling the user to be automatically repositioned to that last known location.

The following description is broken into sections. The first section, labeled “environment” describes an exemplary network environment in which embodiments may be implemented. The second section, labeled “components,” describes exemplary logical and physical components used to implement various embodiments. The third section, labeled “operation,” describes exemplary method steps for implementing various embodiments.

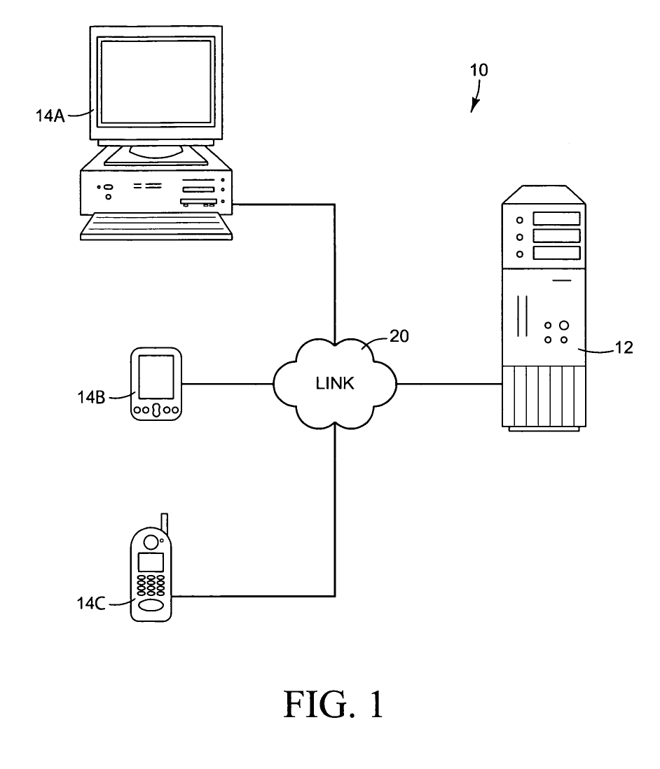

ENVIRONMENT: Although the various embodiments of the invention disclosed herein will be described with reference to the computer network 10 shown schematically in FIG. 1, the invention is not limited to use with network 10. The invention may be implemented in or used with any computer system in which it is desirable for a client to obtain data from a server. Referring to FIG. 1, network 10 represents generally any local or wide area network such as the Internet in which a variety of different electronic devices are linked. Network 10 includes server device 12 and client devices 14A, 14B, and 14C, each referred to generically as client device 14. Client devices 14 represent generally any computing devices capable of requesting and receiving data from server device 12. Client devices 14 are also responsible for displaying the data to their respective users. Server device 12 represents generally any computing device capable of supplying data to client devices 14 in response to requests received from those devices.

Communication link 20 interconnects server device 12 with client devices 14-18. Communication link 20 represents generally a cable, wireless, fiber optic, or remote connection via a telecommunication link, an infrared link, a radio frequency link, or any other connector or system that provides electronic communication between devices 12 and 14. Communication link 20 may represent an intranet, the Internet, or a combination of both. The paths followed by link 20 between devices 12 and 14 in the schematic view of FIG. 1 represents the logical communication paths between these devices, not necessarily the physical paths between the devices. Devices 12 and l4 can be connected to network 10 at any point and the appropriate communication path established logically between the devices.

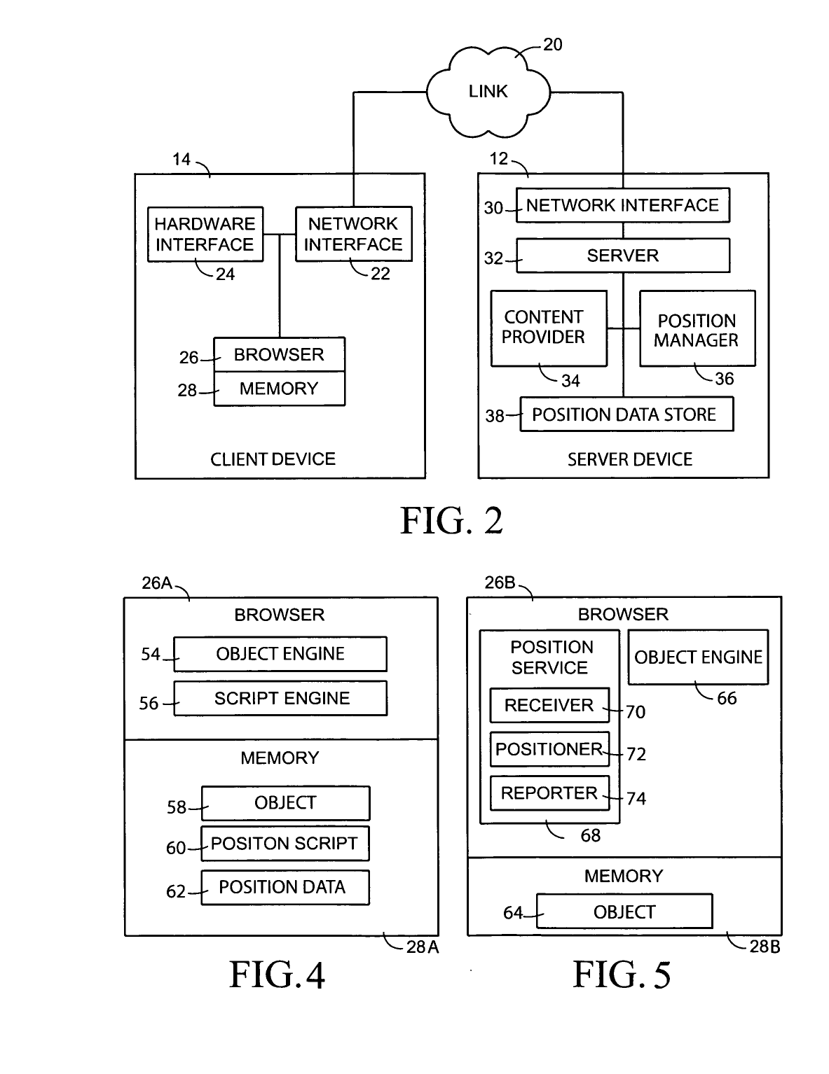

COMPONENTS: The logical components of various embodiments of will now be described with reference to the block diagrams of FIGS. 2-5. Starting with FIG. 2 client device 14 is shown to include network interface 22, hardware interface 24, browser 26, and memory 28. Network interface 22 represents generally any combination of hardware and/or programming configured to enable client device 14 to communicate electronically with server device 12. For example, network interface 22 may include an Ethernet card and supporting device drivers. Alternatively, network interface 22 may be a device capable of wireless communication using protocols such as Bluetooth or 802.11.

Hardware interface 24 represents generally the hardware and programming enabling a user to interact with client device 14. Hardware interface 24 will typically include a display screen and an input device such as a mouse or touchpad and even speakers. The input and display functions of hardware interface 24 may be implemented using a touch screen such as is typically found in a PDA Personal Digital Assistant) or a tablet PC (Personal Computer).

Browser 26 represents generally any combination of hardware and/or programming configured to function as a client for requesting and receiving data from server device. Browser 26 may be a conventional browser such as Mozilla's Firefox™ or Microsoft's Internet Explorer®. Alternatively browser 26 may be a subcomponent of another application such as a word processor or multi-media player. Memory 28 represents generally any memory that can be utilized by browser 26. Broadly speaking, browser 26 requests an object from server device 12. An object may be a web page, a document, a graphics file, motion video content, audio content or anything else that can be presented via a visual display and/or an audible broadcast. An object is typically requested using an appropriate URL (Uniform Resource Locator). The URL references the object and the server responsible for returning the object. An URL may be supplied by a user through hardware interface 24. For example, a user may enter the URL using a keyboard or the user may select a link using a pointing device such as a mouse.

In response to a request from browser 26, server device returns the requested object. Often this is an HTML (Hyper-Text Markup Language) file that may include content and/or references to external content. Content can include various items such as text, documents, still images, video files, and audio files to be presented to a user. Content such as text is often included in the object. However, external content such as applets, documents, still images, video files, and audio files are instead referenced by the HTML object using appropriate links. When processing an HTML object, browser recognizes those links and downloads any external content.

After processing or otherwise examining a requested object, browser 26 causes hardware interface 24 to present the content data. This can involve displaying visual content on a display screen and/or broadcasting audio content through speakers. Displaying the visual content may require more space that is available on a display screen. In such a case, browser 26 presents a user interface with controls that allow the user to scroll up and down and, in some cases, left and right to reposition the display and reveal otherwise hidden portions of the visual content. Audio and motion video content, by their nature cannot be presented all at once. Instead, they have a duration and are presented over time. In such a case, browser 26 may present a user interface with controls that allow the user to skip ahead or skip back to reach a desired playback position.

Server device 12 is shown to include network interface 30, server 32, content provider 34, position manager 36, and position data store 38. Network interface 30 represents generally any combination of hardware and/or programming configured to enable server device 12 to communicate electronically with client device 14. For example, network interface 30 may include an Ethernet card and supporting device drivers. Alternatively, network interface 30 may be a device capable of wireless communication using protocols such as Bluetooth or 802.11.

Server 32 represents generally any combination of hardware and programming configured to receive object requests from and returning requested objects to client device 14. Content provider 34 represents generally any combination of hardware and/or programming configured to provide server 32 with a requested object. Content provider 34 may simply retrieve and provide server 32 with a previously created object. Alternatively, content provider may dynamically generate the object in response to the particular request received by server 32. Content data for an object may be stored on server device 12 or on another server device (not shown) accessible to client device 14.

Position manager 36 represents generally any combination of programming and/or hardware configured to manage position data store 38. Position manager 36 is responsible for providing server 32 with position data to return with a requested object, obtaining the position data from position data store 38. Position data is any data that identifies a position for presenting an object. Position data may include pixel coordinates. For example, an object might fill a grid of 2,000 by 6,000 pixels. Position data might then identify coordinates within that grid. Programming displaying the object can then use the coordinates to automatically position the display. The coordinates could define a center point or even a window to be displayed. Position data may instead identify a page of a document or a start time for video or audio content. Position data store 38 represents generally one or more databases in which position data is associated with an object and a user.

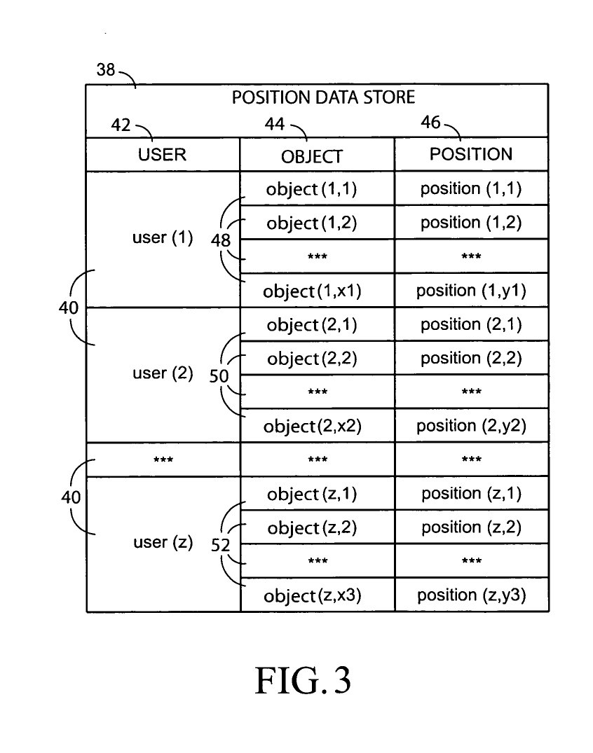

FIG. 3 is an exemplary block diagram illustrating position data store 38. In this Example, position data store 38 is used to associate a user with an object and position data. Here position data store 38 includes entries 40. Each entry 40 includes a user field 42 and one or more object and position fields 44 and 46. Data contained in user field 42 for a particular entry 40 associates the entry 40 with a particular user. Data in user field 42 might be user specific information such as a user name and a password. It may instead be client specific such as a cookie or other like identifier.

Each entry 40 includes one or more sub entries 48-52 each containing data in object field 44 and position field 46. Data in object field 44 identifies a particular object such as a web page, document file, or multimedia content. Position field 46 of a particular sub entry 48-52 contains position data. As noted above, depending on the nature of the object, position data can identify pixel coordinates, a particular page of a document, or even a start position for audio and video contents. In this manner, position data store 38 associates position data with an object and a user.

With reference to FIGS. 2 and 3, upon receiving a request for an object, server 32 can pass object identifying data along with user identifying data on to position manager 36. As noted, the user identifying data may be client or user specific. The object identifying data, for example, may be an URL or portion thereof. Position manager 36 can utilize the user identifying data to locate a corresponding entry 40 in position data store 38. Utilizing object identifying data, position manager 36 can then locate a corresponding subentry 48, 50 or 52. From that subentry, position manager 36 can obtain position data to be returned with the requested object.

Position manager 36 is also responsible for adding new entries/subentries and updating existing entries/subentries within position data store 38. From time to time server 32 will receive updated position data for a particular object and pass that information on to position manager 36. Position manager 36 can then add or update a corresponding entry/subentry within position data store 38.

FIGS. 4 and 5 help illustrate exemplary client-side solutions showing alternative implementations of using Browser 26 (FIG. 2) to automatically position a display of an object utilizing position data. Referring first to FIG. 4, browser 26A is shown to include object engine 54 and script engine 56. Object engine 54 represents generally any combination of hardware and/or programming configured to request, receive, and process objects. As noted above, an object may be an HTML file, a document, a media file, or even streaming media. Processing an object includes presenting the object to a user. Where a given object is an HTML file, processing includes examining the HTML file and retrieving and presenting content referenced by the HTML file.

Script engine 56 represents generally any combination of hardware and/or programming configured to execute scripts contained in objects processed by object engine 54. A script is a list of commands that can be executed without user interaction. Scripts can be written in a number of different script languages such as JavaScript®. 4 In FIG. 4, browser 26A has placed object 58, position script 60, and position data 62 in memory 28A. While shown as three distinct items, two or more of object 58, position script 60, and position data 62 may be integrated in a single file. For example, object 58 may be an HTML file that includes position script 60, and position script 60 may include position data 62. Object 58 represents an object requested from server device 12 and received by object engine 54. When presented, object 58 may include, for example, text, images, motion video, and/or audio. Position script 62 represents a script, that when executed by script engine 56, causes object engine 54 to automatically position a presentation of object 58 according to position data 62. Where object 58 is a web page or an image, position data 62 might include pixel coordinates. Where object 58 is a document, position data 62 may be a page identifier. Where object 58 is motion video or audio, position data 62 may identify a starting position within the motion video or audio. For example, where object 58 is streaming audio or video five minutes in duration, position data may identify a particular starting position of three minutes.

Position script 60 also includes commands that when executed by script engine 56, cause object engine 54 to report updated position data to server device 12. The updated position data, for example, may correspond to the position of a presentation of object 58 as the presentation being closed. Closing a presentation of an object may involve presenting another object. For example, a user may select a link within the presentation of object 58 that causes object engine 54 to retrieve and present a different object. Closing may also involve the user exiting browser 26A.

Moving to FIG. 5, browser 26B has placed object 64 in memory 28B. Browser 26B is shown to include object engine 66 and positioning service 68. Object engine 66 represents generally any combination of hardware and/or programming configured to request, receiving, and processing objects. As noted above, an object, for example, may be an HTML file, a document, media file, or even streaming media. Processing an object includes causing displaying content data for the object. Where a given object is an HTML file, processing includes examining the HTML file and retrieving and displaying content data referenced by the HTML file.

Position service 68 represent generally any combination of hardware and/or programming configured to cause object engine 66 to automatically position a presentation of object 64 according to position data. Position service 68 is also responsible for causing object engine 66 to report updated position data to server device 12. Position service 68, for example, may be a browser “plug-in” or “extension” that adds the specified services to browser 26B. While shown as being integral to browser 26B, position service 68 may be a separate component capable of programmatic interaction with browser 26B.

Position service 68 is shown to include receiver 70, positioner 72, and reporter 74. Receiver 70 is responsible for receiving or otherwise obtaining position data from server device 12. Positioner 72 is responsible for causing object engine 66 to automatically position the presentation of object 64 according to the position data received by receiver 70. Reporter 74 is responsible for reporting updated position data to server device 12. As above, the updated position data, for example, may correspond to the position of a presentation of object 64 as the presentation being closed. Closing a presentation of an object may involve presenting another object. For example, a user may select a link within the presentation of object 64 that causes object engine 66 to retrieve and present a different object. Closing may also involve the user exiting browser 26B.

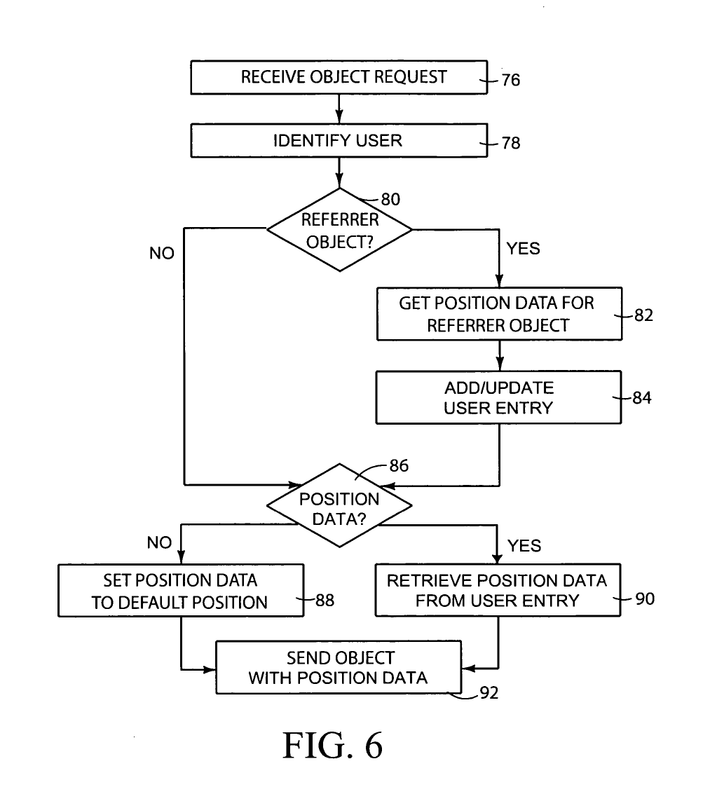

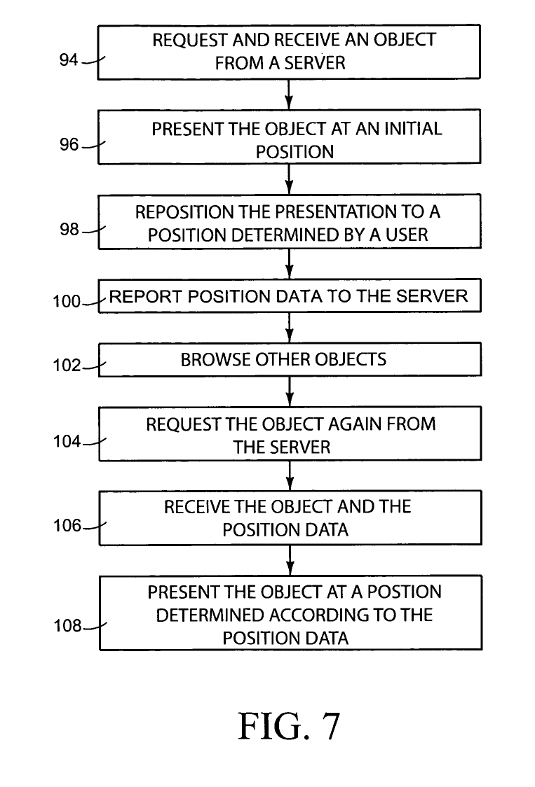

OPERATION: The operation of embodiments will now be described with reference to the flow diagrams of FIGS. 6 and 7. FIG. 6 is a flow diagram of exemplary acts for a server side implementation. FIG. 7 is a flow diagram of exemplary acts for a server side implementation. Starting with FIG. 6; a request for an object is received from a client device (step 76). A user of the client is identified (step 78). The user may be identified inferentially through a cookie or other client specific identifier. The user may be identified more directly through a user specific identifier such as a user name and password pair.

It is next determined if the request received in step 76 originated from a referrer object (step 80). A referrer object is an object being presented to a user that refers the user to the particular object requested. For example, an object may be a web page with a link to the requested object. Upon selection of the link, the object containing the link is known as a referrer object. Where a user requests an object without selecting such a link, there is no referrer object.

Where the request does not originate from a referrer object, the process skips to step 86. Where the request originated from a referrer object, position data is obtained for the referrer object (step 84). The position data may reference the position in the presentation of the reference object at which the request in step 76 was made. The position data is then used to update a corresponding data base entry (step 84), that is, the data base entry associating the referrer object with the identified user. Referring back to FIGS. 2 and 3, step 84 may involve position manager 36 adding or updating an entry 40 in position data store 38. In the example of FIG. 3, an entry 40 would be added if no entry exists for the user identified in step 78. An entry 40 would be updated if an entry exists for the identified user. Adding or updating an entry allows position data to be associated with an object and a user. In this manner, when receiving a subsequent request and determining it to be from the same user for the same referrer object, the updated position data can be supplied with the object. The requesting client device can then use the position data to automatically position the presentation of the object.

It is next determined if position data exists for the identified user and the requested object (step 86). Referring back to FIGS. 2 and 3, step 86 may involve position manager 36 searching position data store 38 for an entry 40 associated with the user identified in step 78 and the object requested in step 76. If no such entry exists, position data to be returned with the request object is set to a default position for that object (step 88). If position data for the requested object and the identified user is found in step 86, the position data is retrieved from the appropriate database entry (step 90). The requested object is then sent with the position data retrieved in step 90 (step 92).

Moving on to the client side implementation of FIG. 7, an object is requested and received from a server (step 94). Referring back to FIG. 2, step 94 may involve browser 26 using an URL to request the object from server device 12. The object is presented at an initial or default position (step 96). The presentation of the object is repositioned to a position determined by a user (step 98). Where the object is a web page, step 98 may involve a user scrolling to a desired position. Where the object is a multi-page document, step 98 may involve the user opening a particular page. Where the object is motion video content or audio content, step 98 may simply involve the user pausing or stopping playback at a particular position.

Position data is then reported back to the server (step 100). Step 100 may, for example occur when the presentation of the object is closed. As mention earlier, a presentation may be closed by browsing other objects (step 102). The object is again requested from the server (step 104). The object is received as is the position date previously reported in step 100 (step 106). The object is then automatically presented at a position determined according to the position data (step 108). In this manner the user is automatically returned to the last known position in the presentation of the object, that is, the position determined in step 98.

FIGS. 6 and 7 illustrate steps taken to implement particular embodiments. However, it is important to note, that other embodiments may use fewer or more steps. For example, with respect to the server-side implementation of FIG. 6, an exemplary embodiment may simply involve obtaining position data associated with an object and then sending the object with the position data to a client that requested the object. With respect to the client side implementation of FIG. 7, an exemplary embodiment may simply involve requesting and receiving an object from a server and then presenting the object at an initial position. After the presentation is repositioned to a position determined by a user, corresponding position data is reported back to the server.

### CONCLUSION

The schematic diagram of FIG. 1 illustrates an exemplary network environment in which embodiments may be implemented. Implementation, however, is not limited to the network environment shown. The block diagrams of FIGS. 2-5 show the architecture, functionality, and operation of various embodiments of the present invention. A number of the blocks are defined at least in part as programs. Each of those blocks may represent in whole or in part a module, segment, or portion of code that comprises one or more executable instructions to implement the specified logical function(s). Each block may also represent a circuit or a number of interconnected circuits to implement the specified logical function(s).

Also, the present invention can be embodied at least in part, in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes, hard drives or a portable compact disc.

Although the flow diagrams of FIGS. 6 and 7 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A persistent positioning method, comprising:
obtaining position data associated with an object; and
sending the object with the position data to a client requesting the object, the position data usable by the client to position a presentation of the object.

2. The method of claim 1, wherein the request for the object originated from a user of the client and wherein obtaining comprises obtaining position data associated with the user and the object.

3. The method of claim 1, wherein obtaining comprises obtaining position data associated with the client and the object.

4. The method of claim 1, further comprising receiving updated position data and associating the updated position data with the object.

5. The method of claim 1, further comprising receiving updated position data and associating the updated position data with the object and a user from which the request for the object originated.

6. A persistent positioning method, comprising:
receiving a first request for an object from a client;
returning the object to the client, the object including a position script;
receiving position data from the client, the position data having been generated by an execution of the position script;
receiving a second request for the object from the client;
returning the object and the position data to the client, the object including the position script that when executed utilizes the position data to position a presentation of the object by the client.

7. The method of claim 6, wherein:
the first request originated from a user; and
returning the object and the position data to the client comprises returning the object and the position data to the client upon a determination that the second request originated from the user, the object including the position script that when executed utilizes the position data to position a presentation of the object by the client.

8. A persistent positioning method, comprising:
requesting and receiving an object from a server;
presenting the object for view by a user at an initial position;
repositioning the presentation of the object to a position determined by the user;
reporting position data to the server, the position data at least indirectly identifying the position determined by the user.

9. The method of claim 8, further comprising again requesting the object from the server;
again receiving the object and the position data from the server;
automatically positioning a presentation of the object according to the position data.

10. The method of claim 8, wherein the act of reporting is performed upon exiting the presentation of the object.

11. A computer readable medium having instructions for:
obtaining position data associated with an object; and
sending the object with the position data to a client requesting the object, the position data usable by the client to position a presentation of the object.

12. The medium of claim 1 1, wherein the request for the object originated from a user of the client and wherein the instructions for obtaining include instructions for obtaining position data associated with the user and the object.

13. The medium of claim 11, wherein the instructions for obtaining include instructions for obtaining position data associated with the client and the object.

14. The medium of claim 11, having further instructions for receiving updated position data and associating the updated position data with the object.

15. The medium of claim 11, having further instructions for receiving updated position data and associating the updated position data with the object and a user from which the request for the object originated.

16. A computer readable medium having instructions for:
receiving a first request for an object from a client;
returning the object to the client, the object including a position script;
receiving position data from the client, the position data having been generated by an execution of the position script;
receiving a second request for the object from the client;
returning the object and the position data to the client, the object including the position script that when executed utilizes the position data to position a presentation of the object by the client.

17. The medium of claim 16, wherein the first request originated from a user, and wherein instructions for returning the object and the position data to the client include instructions for returning the object and the position data to the client upon a determination that the second request originated from the user, the object including the position script that when executed utilizes the position data to position a presentation of the object by the client.

18. A computer readable medium having instructions for:
requesting and receiving an object from a server;
presenting the object for view by a user at an initial position;
repositioning the presentation of the object to a position determined by the user;
reporting position data to the server, the position data at least indirectly identifying the position determined by the user.

19. The medium of claim 18, having further instructions for:
again requesting the object from the server;
again receiving the object and the position data from the server;
automatically positioning a presentation of the object according to the position data.

20. The medium of claim 18, wherein the instructions for reporting are executed upon exiting the presentation of the object.

21. A persistent positioning system, comprising a server and a position manager, wherein:
the position manager is operable to, following a request for an object, to obtain position data associated with the object and to supply the object and the position data to the server; and
the server is operable to send the object with the position data to a client requesting the object, the position data usable by the client to position a presentation of the object.

22. The system of claim 21, wherein the request for the object originated from a user of the client and wherein the position manager is operable to obtain position data associated with the user and the object.

23. The system of claim 21, wherein the position manager is operable to obtain position data associated with the client and the object.

24. The system of claim 21, wherein the server is operable to receive updated position data to supply the updated position data to the position manager and wherein the position manager is operable to associate the updated position data with the object.

25. The system of claim 21, wherein the server is operable to receive updated position data to supply the updated position data to the position manager and wherein the position manager is operable to associate the updated position data with the object and a user from which the request for the object originated.

26. A persistent positioning system, comprising:
a means for receiving a first request for an object from a client;
a means for returning the object to the client, the object including a position script;
a means for receiving position data from the client, the position data having been generated by an execution of the position script;
a means for receiving a second request for the object from the client;
a means for returning the object and the position data to the client, the object including the position script that when executed utilizes the position data to position a presentation of the object by the client.

27. The system of claim 26, wherein:
the first request originated from a user; and
the means for returning the object and the position data to the client comprises a means for returning the object and the position data to the client upon a determination that the second request originated from the user, the object including the position script that when executed utilizes the position data to position a presentation of the object by the client.

28. A persistent positioning system, comprising:
a position script having executable instructions for reporting a position data;
an object engine operable to requesting and receiving an object from a server, the object including the position script, to present the object for view by a user at an initial position, and to reposition the presentation of the object to a position determined by the user;
a script engine operable to execute the position script to report the position data to the server, the position data at least indirectly identifying the position determined by the user.

29. The system of claim 28, wherein:
the position script includes executable instructions for automatically positioning the presentation of the object;
the object engine is operable to receive position data from the server;
the script engine is operable to execute the position script to cause the object engine to automatically reposition the presentation of the object according to the position data.

30. The system of claim 28, wherein the position script includes executable instructions for reporting the position data upon the object engine exiting the presentation of the object.

31. A persistent positioning system, comprising:
a receiver operable to obtain position data for an object received by an object engine from a server;
a positioner operable to cause the object engine to automatically position a presentation of the object according to the position data; and
a reporter operable to report updated position data to the server, the updated position data at least indirectly identifying a position for presenting the object as determined by a user.

32. The system of claim 28, wherein the reporter is operable to report the updated position data upon the object engine exiting the presentation of the object.

33. A persistent positioning method, comprising:
a means for requesting and receiving an object from a server;
a means for presenting the object for view by a user at an initial position;
a means for repositioning the presentation of the object to a position determined by the user;
a means for reporting position data to the server, the position data at least indirectly identifying the position determined by the user;
a means for again requesting the object from the server;
a means for again receiving the object and the position data from the server;
a means for automatically positioning a presentation of the object according to the position data.
